(19) United States
(12) Patent Application Publication
(10) Pub. No.: US 2009/0207983 A1
(43) Pub. Date: Aug. 20, 2009

(54) Method and a system for delivering messages to calling parties

(75) Inventor: Bahram Nour-Omid, Los Angeles, CA (US)

Correspondence Address: MARTIN D. MOYNIHAN d/b/a PRTSI, INC., P.O. BOX 16446, ARLINGTON, VA, 22215, US

(73) Assignee: Dialware Inc., Los Angeles, CA (US)

(21) Appl. No.: 12/071,113

(22) Filed: Feb. 15, 2008

(51) Int. Cl. H04M 1/64

(52) U.S. Cl. 379/88.23

(57) ABSTRACT

A method for delivering a message to a calling party. The method comprises receiving a destination number of a destination party via a network. The destination number is dialed by a calling party. The method further comprises identifying data that characterizes the destination party, selecting one or more messages from a plurality of messages according to the identified data, and delivering the at least one message to the calling party.

### FIELD OF THE INVENTION

This invention, in some embodiments thereof, relates to delivering a message responsive to dialing a phone number. Some embodiments relate to delivering advertisements based on a dialed number.

### BACKGROUND OF THE INVENTION

Some organizations provide telephonic or other advertisements according to a caller's preferences, for example, http://www.jajah.com or http://www.apptera.com, the disclosures of which are incorporated herein by reference.

### SUMMARY OF THE INVENTION

Some embodiments of the present invention relates to a method for delivering a message to a dialing party based on a phone number dialed by the party.

In some embodiments of the invention, the message is selected according to data related to the phone number.

Some embodiments of the present invention relates to a method for delivering a message to a calling party. The method comprises receiving a destination number of a destination party via a network, the destination number being dialed by a calling party, identifying data characterizing the destination party, selecting at least one message from a plurality of messages according to the identified data, and delivering the at least one message to the calling party.

Optionally, the selecting is performed by a third party other than the destination and calling parties.

Optionally, each one of the plurality of messages comprises at least one advertisement.

Optionally, the data comprises information obtained based on a member selected from a group consisting of the destination number and previously obtained related data thereof.

Optionally, the identifying comprises searching at least one information store according to a member selected from a group consisting of the destination number and previously obtained related data thereof.

More optionally, the at least one information store comprises a member selected from a group consisting of: a phone directory, a business directory, social networks, business networks, a database, a data network, a computer folder, a computer document and the Internet.

More optionally, the identifying and the selecting are performed irrespective of (a).

More optionally, the searching is carried out by a member selected from a group consisting of: the third party and a party affiliated with the third party.

Optionally, the data comprises information obtained based on data related to parties that called the destination party.

Optionally, the method further comprises associating the data with the destination number and storing the associated data before the selecting.

More optionally, the identifying, the selecting, and the associating are performed irrespective of the receiving.

Optionally, the identifying comprises matching between the content of the plurality of messages and the data and selecting the at least one message from the plurality of messages according to the matching.

More optionally, the matching comprises finding at least one word in the plurality of messages that has at least one of a similar, an analogous or a synonym meaning as at least one word in the data.

Optionally, selecting further comprises selecting according to a member selected from a group consisting of a geographical locality of the calling party and a message already delivered to the calling party.

Optionally, the at least one message comprises a member selected from a group consisting of: a text segment, a graphic, an image, an audio file, and a video file.

Optionally, the at least one message comprises an audio sequence comprising a member selected from a group consisting of a recorded sound, a synthesized sound, and a machine reading voice.

Optionally, the at least one message comprises a media file, the delivering comprises playing the media file during a pause in a telephonic connection between the calling party and the destination party.

Optionally, the delivering comprises sending the at least one message in a member selected from a group consisting of: a short message service (SMS), a multimedia messaging service (MMS), a phone call, an email and a mail service.

Optionally, the receiving comprises receiving a paging call from the calling party.

Optionally, the method further comprises benefiting the calling party from the delivering.

Optionally, the method further comprises receiving the consent of the calling party for receiving the at least one message before the delivering.

Some embodiments of the present invention relates to a method for delivering an advertisement to calling party. The method comprises receiving a destination number of a destination party from a calling party, selecting an advertisement according to data related to the destination number, and delivering the advertisement to the calling party.

Some embodiments of the present invention relates to a system for delivering a message to calling party. The system comprises a database having a plurality of destination numbers each associated with a destination party and charactering data related to the destination party and a receiving unit for receiving one of the plurality of destination numbers. The received destination number is dialed by a calling party. The system further comprises a messaging unit for selecting at least one message from a plurality of messages by matching between respective charactering data associated with the received destination number in the database and the plurality of messages. The system further comprises a delivering unit for delivering the at least one selected message to the calling party.

Optionally, the delivering unit is for using a telephone service for sending the at least one selected message to the calling party.

Optionally, each one of the plurality of messages comprises an advertisement.

Optionally, the messaging unit is for selecting the at least one message from an advertisement service providing an access to the plurality of messages.

Optionally, each said characterizing data is updated from at least one information store hosting information about a respective the associated destination party.

More optionally, the at least one information store comprises a member selected from a group consisting of: a phone directory, a business directory, social networks, business networks, a database, a data network, a computer folder, a computer document and the Internet.

Optionally, at least some of the plurality of messages comprises a member selected from a group consisting of: a text segment, a graphic, an image, an audio file, and a video file.

Optionally, the delivering unit is for delivering the selected message in a member selected from a group consisting of a short message service (SMS), a multimedia messaging service (MMS), a phone call, a paging call, an email and a mail.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the accompanying drawings, identical and/or equivalent and/or similar structures, elements, or parts that appear in more than one drawing are generally labeled with the same numeral in the drawings in which they appear. Dimensions of components and features shown in the figures are chosen for convenience or clarity of presentation and are not necessarily shown to scale.

FIG. 1 is a flowchart that illustrates a sequence of events in delivering a message to a caller dialing a phone, in accordance with exemplary embodiments of the invention;

FIG. 2 schematically illustrates a system for delivering to a caller that dialed a phone number a message based on data which has been acquired by searching information stores based on the dialed phone number, in accordance with exemplary embodiments of the invention;

FIG. 3 is a flowchart schematically illustrating finding a party based on a phone number, in accordance with exemplary embodiments of the invention; and

FIG. 4 is a flowchart schematically illustrating a network search for phone party attributes, in accordance with exemplary embodiments of the invention.

### DESCRIPTION OF EMBODIMENTS OF THE INVENTION

An aspect of some exemplary embodiments of the invention relates to delivering to a calling party (‘caller’) that dialed a number of another party (‘destination’) a message selected according to data related to the dialed number and/or party thereof.

In some embodiments of the invention, a message comprises an advertisement. In the specifications, unless otherwise specified, the terms ‘message’ and ‘advertisement’ are used interchangeably.

In some embodiments of the invention, the data related to a phone number party is obtained by searching information stores, based on the dialed number and/or related data thereof.

In some embodiments of the invention, an information store comprises organization or service or establishment such as a phone directory (e.g., White pages), a business directory (e.g., D&B and Golden pages), social networks (e.g., MySpace™), business networks (e.g., LinkedIn™), a database, a data network, a computer folder, a computer document or the Internet. Typically, without limiting, an information store comprises an online store. Optionally or alternatively, an information store comprises any document.

The data related to a phone number and/or party is discussed below.

The non-limiting section headings used herein are intended for convenience only and are not to be considered as necessarily limiting the scope of the invention.

### Events Sequence Example

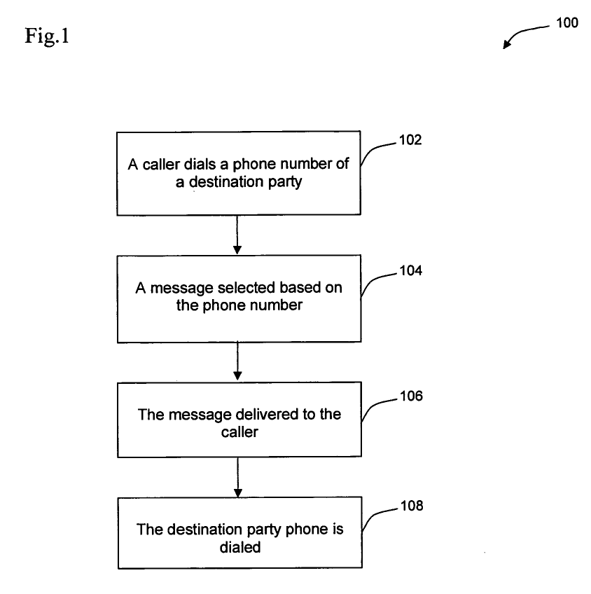

FIG. 1 schematically illustrates a sequence 100 of events in delivering a message to a caller dialing a phone, in accordance with exemplary embodiments of the invention.

In some embodiments of the invention, a caller dials a phone number of a destination party (102). Contrary to a typical phone operation where the destination party phone or any other user terminal is straightaway dialed in order to set a telephonic connection with the caller, in some embodiments of the invention a message is selected based on the dialed phone number (104) and delivered to the caller (106), such as by playing the message to the caller, prior to dialing the destination (108). As used herein, a user terminal means telephone set, a cellular phone, a Smartphone, or a computing unit having an application for making voice and/or video calls, such as Voice over Internet Protocol (VoIP) calls.

### Middle Parties

Typically, without limiting, in some embodiments of the invention the message is delivered by a party intermediate between the caller and the destination, such as a communication party. Optionally, the communication party comprises organizations such as a communication service, a telecom network, a telephone operator or a telephone service or a paging service or other communication service (e.g., VOIP service). In some cases and/or in embodiments of the invention, a communication party is cooperating and/or affiliated with an advertisement party or service, such as an organization collecting and/or producing and/or delivering advertisements (also denoted as an advertisement party). In some cases and/or in embodiments of the invention, the communication party and the advertisement party are the same organization, or a part thereof.

In some embodiments of the invention, a set of one or more modules, such as software components, is handling the message selection and/or delivery (a ‘dispatcher’), optionally on behalf of the communication part and/or advertising party. Optionally, the dispatcher executes on hardware of one or more of the communication party or advertisement party or a separate hardware, such as server or servers. In some embodiments of the invention, the dispatcher interacts with the communication party and with the advertisement party in order to select and/or access and/or deliver a message. For example, the dispatcher obtains the phone number from the telephone party, and based on the phone related data (see below) the dispatcher selects a message from the advertisement party and provides the message to the telephone party for delivery. Optionally, the telephone party, optionally using the dispatcher, interacts and/or controls the searching for data related to a phone number party.

In some embodiments of the invention, the interaction between a communication party and the advertisement party, optionally involving interaction with the dispatcher, renders the communication party operative to get messages for delivery.

In some embodiments of the invention, other parties or organizations are involved in message delivery. For example, the user terminal of the calling party may be configured by the manufacturer, e.g., by software modules, to send a dialed number to the manufacturer of the equipment, which subsequently delivers messages to the calling party. Or, for example, the calling party accepts to let the user terminal configured to send a dialed number to an advertising service, e.g., for a payment or a reward such as free internet connection.

In the specifications and claims, unless otherwise specified, a communication party, intermediate between a caller and a destination, is denoted as a ‘telephone service’ an advertisement party is denoted as a ‘advertisement service’, and a communication service and/or other organization operative to provide messages is denoted as a ‘third party’.

In some embodiments of the invention, in cases when a destination party is called by other manners than dialing a phone number, such as paging a party via a paging service (paging call), the destination party identification (e.g., number or code or name) is handled, at least partly, similar to a dialed phone number. Unless otherwise specified, such identification is regarded as a phone number and calling a service such as a paging service is regarded as dialing a number.

### Schematic Example Of Audio Message Delivery

In some embodiments of the invention, a message is delivered responsive to dialing the destination number. In some embodiments of the invention, the message is repetitively delivered as long as the destination party does not accept the call. In such an embodiment, an audio message or a message comprising audio (e.g., video) is played to the caller instead of a ring tone or a part of a ring tone. Optionally or alternatively, the destination is not dialed until the message is delivered. Optionally or alternatively, the destination is dialed before the message comprising audio, video, or a combination thereof ends, but the call is suspended, for example, the phone does not ring until the message is delivered. In some embodiments of the invention, a telephonic connection is set between the caller and the destination party, optionally after an audio or video message is delivered. Optionally, a message that comprises media file, such as an audio file, graphics, a video file and/or a combination thereof is delivered during pauses in the telephonic conversation or when the connection is put on hold (e.g. the destination party puts the caller on hold while doing some work for the caller, such as inquiries) or when the destination is on a call (call waiting) or busy. Optionally, the media file is sent with a set of one of more operational instructions for activating one or more functions of the caller terminal, for example vibrating, playing a ringtone, and activating one or more light emitting elements, such as light emitting diodes (LEDs). It should be noted that playing the advertisements during these pauses is assumed to be more efficient than advertisements which are played during a conversation and/or any other communication. As caller is waiting for a reaction or an action of the other party, she is relativity attentive to the voices and/or sounds which are played by the user terminal that she uses.

Optionally, the message is played after the call is terminated by the destination. Optionally, the caller is called after the connection and a message is played.

In some embodiments of the invention, a message having a content that is represented as a text segment, a graphic element, an image, an audio file, and/or a video file is delivered to the caller party during a communication session, such as a phone call between the caller and destination party, where optionally the contact comprises audio such as conversation or video call or conference. For example, when the user terminal of the caller party is equipped with a screen, then during the conversation between the parties a message is delivered to the user terminal of the user terminal of the calling party, such as an image or a moving text banner (in the fashion of the known Times Square banner). Or, for example, when a video call is carried out between the parties, a moving banner is delivered to the calling party to be displayed on the upper or lower edge of the screen, or an image is delivered to be displayed as a Picture-In-Picture (PIP) in the video screen of the user terminal of the calling party.

A general outline of some embodiments of the invention is illustrated by the following non-limiting scenario of an audio message delivery, comprising:
(a) Dialing a destination party number by a caller via a telephone service;
(b) Connecting the caller to a third party;
(c) Finding data related to the number;
(d) Selecting a message according to the related data;
(e) Playing the message to the caller by the third party; and
(f) Dialing the destination party by the telephone service.

It should be noted that operation (f) is provided to illustrate that eventually the caller may dial the destination party.

### Characteristics (Data Related to a Phone Party)

In some embodiments of the invention, a phone number such as the dialed number is associated (e.g., linked or coupled or tagged) with one or more data items related to the number, and hence related to the destination party. In some embodiments, the related data comprise data that characterize, or portray or represent or pertain to the role or occupation or business or activities or interests or locality of the destination party. The related data is referred to as characteristics or attributes of the number, and hence of the destination party. The detection and association of characteristics with the number and/or party are discussed below.

In some embodiments of the invention, a characteristic comprises one or more key-words, where a key-word optionally comprises a plurality of words. Optionally, a characteristic comprises an identifier such as a name, optionally comprising one or more words. Optionally, a characteristic comprises a description comprising one or more words, such as an address or business type. Optionally, a characteristic comprises other entities such as a URL (uniform/universal resource locator, e.g., an Internet site address).

In some embodiments, the characteristics are used to identify and/or locate and/or select a message that fits or suits or applies to the destination party in terms such as business or activities. For example, if the destination party is associated (e.g., linked or coupled) with characteristics comprising the words ‘movies’ and ‘theater’ then a message announcing new releases from a movie studio may be selected.

It should be noted that in some embodiments of the invention, one or more characteristics of a phone number may apply to one or more other phone numbers.

In some embodiments of the invention, characteristics of a dialed phone number may be obtained, or derived or compiled based on attributes of or other data related to calling parties that called the destination party. Such related data is obtained, for example, based on the respective CID. In some embodiments of the invention, the attributes of the calling party are obtained by searching information stores according to a number as described below. In some embodiments of the invention, in order to establish characteristics of a dialed party based on the calling parties some criteria may be used, such as a requiring a minimal number of callers having the same of similar attributes, or having attributes related to a common topic.

### Messages (Advertisements)

In some embodiments of the invention, a message comprises text, graphics, image or audio. In some embodiments an audio message comprises a sequence of sounds such as a recording or a synthesized sound. Optionally, the synthesized sound comprises a machine aided and/or generated music or text reading. In some embodiments of the invention, a text message is converted to voice and delivered as a voice message. In some embodiments of the invention, a voice message is converted to text. In some embodiments of the invention, a message comprises a video message, such as a video clip or a movie (e.g., motion pictures).

In some embodiments, the message is delivered, or sent, to the caller in one or more manners, such as voice, text, video, graphics or pictures or music. For example, a message is played during a telephonic connection. Or, for example, after dialing the destination number or after a telephonic conversation, a message is played and/or an a short message service (SMS), or a multimedia messaging service (MMS) is sent, or a phone call is initiated by dialing the caller, such as according to a CID (caller identification).

In some embodiments of the invention, if the caller email or address is known by the telephone service, or otherwise found such as by a search (see later), an email and/or regular mail message is optionally sent to the caller.

In some embodiments of the invention, a message comprises data or instructions to identify and/or locate and/or select another message. Optionally, the message comprises instructions to construct or assemble another message.

In some embodiments of the invention, a massage comprises or is associated (e.g., linked or coupled) with information about the message and/or activation thereof, such as type of the message (e.g., text, audio, image), size of the message, contents of the message, frequency of delivering the message, duration of delivering the message (such as sound), age (relevance) of the message, or other information such as callers that received the message (in one or more manners).

In some embodiments of the invention, a message comprises, or associated (e.g., linked or coupled) with key-words or other data items that characterize or pertains to the message contents. For example, ‘movies’, ‘supermarket’, ‘concert’, ‘science fiction’, ‘internet provider’, etc. Optionally, the message key-words are used to match between a message and a phone number. Optionally, using the key-words enables a faster match with a phone number relative to searching the message contents each time the caller dials.

In some embodiments of the invention, a massage is associated (e.g., linked or coupled) with or related to information pertaining to the costs incurred and/or revenues obtained in providing and/or delivering the message.

### Selecting a Message

In some embodiments of the invention, a message is selected by seeking a match, preferably without limiting, a best match between a message and phone party. In some embodiments of the invention, the match is between the contents of potential messages and/or data associated with the potential message and the characteristics of a destination party. Optionally, the message is not related directed to the destination party per se but to and organization or entity characterized by business or activities or interests related to the destination party, optionally promoting a competitor of the destination party.

For example, if a supermarket number is dialed and the number is associated (e.g., linked or coupled) with a key-words ‘supermarket’ and ‘special offers’, a message listing products on sale from a particular supermarket or supermarket network is selected, e.g., via an advertisement service, and played to the caller and/or sent by other manners such as SMS.

As another example, if a music shop is dialed and the number is associated (e.g., linked or coupled) with the key-words ‘music’ and ‘store’, a message comprising the leading seconds of a new song by a particular band is played, and/or optionally sent as a ring tone to the caller phone.

In some embodiments of the invention, a best or suitable match is according to identical words in the message and/or key-words of the message (see above) and phone number party characteristics. Optionally, similar or analogous words, or synonym of words (e.g. ‘depart’ for ‘leave’), or roots of words (stemming, e.g. ‘move’ for ‘moving’), or inflection of words (e.g. ‘moving’ for ‘move’ or ‘go’ for ‘went’, ‘things’ for ‘thing’) are used for a match. Optionally, wild card and/or regular expression mechanisms may be used to match words. Optionally or alternatively, logical combinations such as AND/OR/NOT may be used for a match, for example, ‘supermarket’ AND “appliances’, or ‘electric’ AND NOT ‘appliances’.

In some embodiments of the invention, a best match comprises finding maximal number of words with similar meaning between the message and the destination party and or closer similarity between words, or a combination thereof. Optionally, a word or term has a larger weight (e.g., more pronounced meaning) relative to other words or terms. Optionally, other criteria may be employed to find a best match, such as taking into account the caller as described below.

In some embodiments of the invention, the best match of a message to the dialed party may take into account the caller. For example, the message is targeted to outlets or services in the geographical locality of the caller, e.g., the country, city, and/or neighborhood of the caller, as optionally determined by a data store of the telephone service, a telephone directory, or by the caller CID. Or, for example, a caller may be tracked the third party so that a best match for a particular caller is a message that has not yet delivered to the caller or delivered a certain time ago so it may be considered an a new one.

### Acquiring Messages

In some embodiments of the invention, the advertisements are provided to or acquired by the telephone service and/or advertisement service from one or more companies or other organizations wishing to promote their business or activities or interests (‘advertisers’).

In some cases and/or embodiments of the invention, the advertisements are acquired by the telephone service and/or advertisement service irrespective of phone numbers or dialed phone numbers, for example, in order to distribute the advertisements by other manners such as by the Internet. Optionally or alternatively, the telephone service and/or advertisement service apply to advertisers to provide advertisements for delivery, optionally based on phone numbers and/or phone number party and/or related data thereof.

Typically, without limiting, in some embodiments of the invention the advertisements are acquired irrespective of dialing a party. Optionally, based on characteristics of the dialed number an advertisement service and/or telephone service may apply to advertisers and offer to include an advertisement of the advertisers.

### Searching for Data Related to a Phone Party (‘Characteristics’)

In some embodiments of the invention, a set of one or more modules, such as software components, performs and/or controls the search for and storage of the characteristics of a phone number party (a ‘seeker’). Optionally, the seeker comprises one or more modules working on behalf of it (agents). Optionally, the agents or other modules of the seeker operate in parallel, at least partly. Optionally the seeker executes on hardware of one or more of the communication service or advertisement service or a separate hardware.

In some embodiments of the invention, the seeker is controlled or operated by a telephone service or third party, optionally via the dispatcher. Optionally, the seeker is controlled or operated by a party on behalf of the telephone service or a third party. Optionally, the seeker is controlled or operated by an independent organization affiliated with the telephone service or third party, such as by a contract or commercial interests or joint ownership. For example, the telephone service may contract the services of a company specialized in searching information stores in general and the Internet in particular. Optionally, the affiliated organization updates a database accessible by the telephone service or third party. Optionally, the affiliated organization does not use the seeker or uses a substitute. In the specifications and claims, a party involved in searching for characteristics of a phone number and/or phone party is denoted as a ‘search party’.

In some embodiments of the invention, the search is conducted irrespective to dialing a number. For example, phone numbers are located in the telephone service, or phone directories or other information stores. A phone number is then used to search information stores to obtain data about the phone number party and characteristics of the party. Optionally, the search is conducted responsive to dialing the destination number and the phone party and characteristics are searched and obtained as a part of the message selection and delivery process.

In some embodiments of the invention, a phone party identification characteristic such as the party name is searched for, for example, using one or more phone directories. Optionally, obtaining a party identification characteristic comprise the initial phase of the search.

In some embodiments of the invention, the search is carried out incrementally, for example, using a found identification characteristic (e.g., party name) as a target, other identification characteristics or other characteristics are searched for in phone directories on in information stores or services. As another example, if a key-word related to the phone number or party is found and used as a target for further search or searches to find key-word related to the target key-word.

In some embodiments of the invention, characteristics are saved and/or associated (e.g., linked or coupled) with the phone number, for example, in a database of the telephone service or the advertisement service or another database such as one under the control of the dispatcher or the seeker (see below).

In some embodiments of the invention, a characteristic that is found may be retained or discarded or changed based during a search on the context in which the characteristic appear. For example, if a key-word ‘vegetables’ is found with words like ‘fresh’ (possibly suggesting farms), further search locates a context with the phone or party comprising words such as ‘supermarket’, ‘vegetables’ and ‘fruits’, and the key-word ‘vegetables’ is discarded for a (possibly) better characteristic of a ‘supermarket’.

In some embodiments of the invention, a phone number and/or data related to the phone number, such as phone party characteristics, are searched by navigating information networks such as the Internet (‘web crawling’). Optionally, a phone number and/or a phone party identification characteristic such as name are used as preliminary targets for searching Internet sites. In some embodiments of the invention, once such a target is found in a site, the site is searched for characteristics (e.g., key-words) that characterize or may characterize the phone party. Optionally, a found characteristic is used as a target of searching other characteristics in other locations linked to the site. The continued search may be used linearly, that is, site after site, or in parallel, where a plurality of searches are conducted by following links branching from a site, for example, by activation agents of the seeker. Optionally, the search comprises a recursive search such as after a chain of links is searched, the search backtracks to a former site. In some embodiments of the invention, the site URL is saved and/or associated (e.g., linked or coupled) with the phone number similar to a characteristic, optionally for further search in the site or links therein.

In some embodiments of the invention, characteristics such as key-words are found, at least partly, by modules, such as programs or agents, or by on-line services such as http://www.keyworddiscovery.com/, the disclosure of which is incorporated herein by reference. Optionally, the key words are found similar the manner in which Google (Google Inc., http://www.google.com), the disclosure of which is incorporated herein by reference. Optionally, a key-word search is based on one or more keywords found in other directories and/or sites.

In some embodiments of the invention, the web search is conducted is according to, at least partially, as described and/or referenced in Design and Implementation of a Distributed Crawler and Filtering Processor (http://www.cs.ucr.edu/˜csyiazti/downloads/papers/ngits02/ngits02.pdf) and/or Crawling the Web (http://dollar.biz.uiowa.edu/˜pant/Papers/crawling.pdj) and/or http://en.wikipedia.org/wiki/Web_crawler, and/or a program as in http.//java.sun.com/developer/technicalArticles/ThirdParty/WebCrawler/WebCrawler.java, the disclosures of which are incorporated herein by reference.

Optionally or additionally, the phone number and/or data related to the phone number, such as characteristics, are searched by a search engine such as Google or Yahoo.

### Database

In some embodiments of the invention, the phone numbers, optionally with associated (e.g., linked or coupled) characteristics, are stored in a database. Optionally, the phone numbers and the associated (e.g., linked or coupled) characteristics are stored in separate databases. Optionally, the database or databases are of the phone numbers or the characteristics are owned and/or managed and/or updated by a telephone service or the seeker or the dispatcher.

In some embodiments of the invention, the messages are stored in one or more databases. Optionally, the database or databases are owned and/or managed and/or updated by an advertisement or a messaging service and optionally accessed by the dispatcher. Optionally a message is stored in a database of respective advertiser, where the message is accessed by the telephone service and/or advertisement service and/or the dispatcher.

In some embodiments of the invention, databases such as phone numbers database and messages databases are unified in the same database. Optionally, a database comprises a plurality of partial databases, optionally comprising distributed databases.

In the specifications and claims, unless otherwise specified, the term ‘database’ related to the conventional meaning or to any medium comprising one or more data items accessible and retrievable by a computer.

### Costs and Revenues Overview

Typically, without limiting, providing and/or operating a mechanism for advertisement delivery is driven by revenues and/or other benefits, and some examples and options are discussed in the following outline for some cases and/or embodiments of the invention.

In some cases and/or embodiments of the invention, the advertiser pays per provided advertisements, optionally also per availability time and/or the character of the message, such as type of the message (e.g., text, sound, image), size of the message, contents of the message, duration of delivering the message (such as sound), age of the message. Optionally, the advertiser pays by a delivered message, optionally according to the character of the message and/or frequency of delivering the message, or other information such as specific callers that received the message (in one or more manners). Optionally, the advertiser pays by other regimes, such as according to the destination party and/or its relevance to the advertiser. Optionally, when data related to a caller is available (e.g., by the telephone service), the payment may be according to the advertisement relevance to the caller.

In some cases and/or embodiments of the invention, the advertiser pays the advertisement service. Optionally, the advertiser pays the telephone service, optionally proportionally to the revenue or profit of the advertisement service. Optionally and additionally, the destination party is paid, optionally as a percentage of the revenue or profit of the advertisement service and/or the telephone service. In some embodiments of the invention, other payment regimes are used to compensate and/or pay the advertisement service and/or the telephone service, such as sharing revenues or profits.

In some cases and/or embodiments of the invention, delivering a message to a caller depends on the caller's consent and/or decline to receive messages, optionally according to the message contents or other aspects such as manner of delivery or length of an audio message. A caller consent or refusal to get messages may optionally be according to some preliminary interaction with the telephone service and/or advertisement service and/or third party, or by other methods such as by dialing a certain code, for example, during the message playing or before dialing the destination.

In some cases and/or embodiments of the invention, the caller is compensated (or subsidized) for receiving a message such as by reducing of the telephone bill, optionally responsive to the number and/or character of received messages. Optionally, the phone connection is not billed if accompanied by a message. Optionally, the caller benefits by the telephone service, such as lowering rates or providing other services, such as Internet connections.

### Messages Management Overview

In some cases and/or embodiments of the invention, one or more programs running on one or more computers and/or servers of the telephone service and/or advertisement service monitors and manages activities related to message acquisition, storage, delivery and accounting (‘administration program’).

As an example, the advertisement service may set an account for each advertiser, optionally, with sub-account for each advertisement. Optionally, the administration program sets information about the message and/or activation thereof, such as type of the message (e.g., text, audio, image), size of the message, contents of the message, frequency of delivering the message, duration of delivering the message (such as sound), age (relevance) of the message, or other information such as callers that received the message (in one or more manners).

As an example, the administration program monitors activities of delivering the messages, and optionally produces reports for the advertiser, optionally for billing purpose and or for promoting the advertisement business or for tuning the advertisement responsive to past operation.

### Audio and Other Messages

For clarity and brevity, in the following discussion where an audio message is discussed or referred to, unless otherwise specified, it is taken into account that in addition to or instead of the audio message other messages may be delivered such as SMS, MMS or others messages, some of which are discussed above, and optionally additional audio messages may be delivered, such as after a telephonic connection.

### An Illustrative System

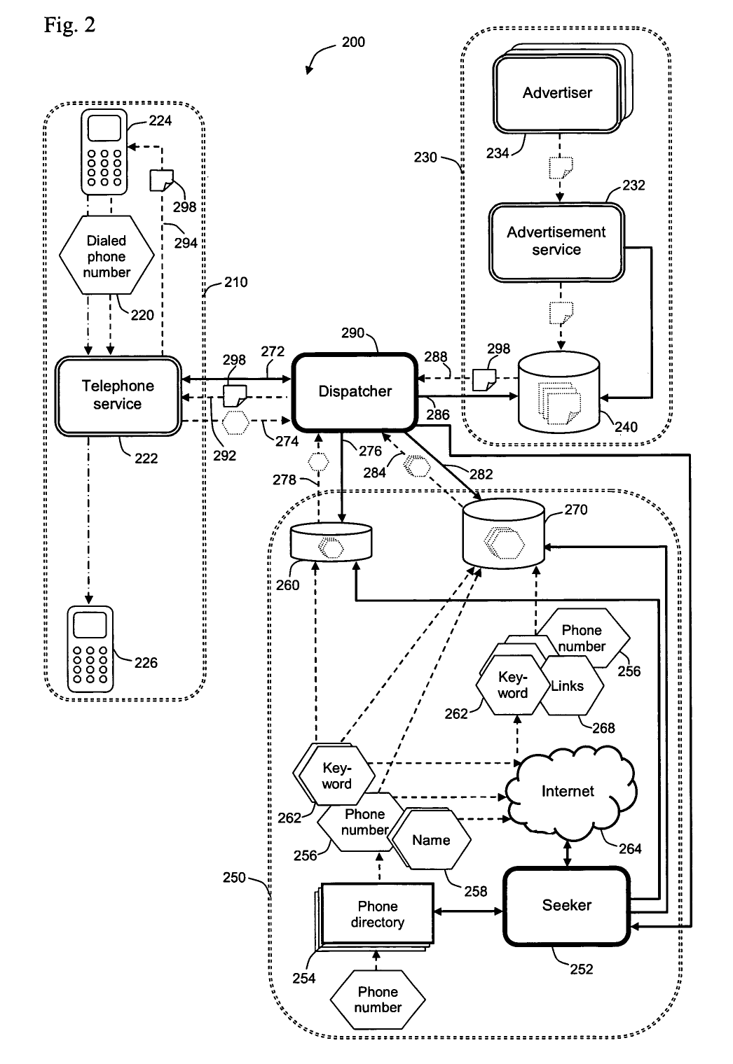

FIG. 2 schematically illustrates a system 200 for delivering to a caller that dialed a phone number a message based on data which has been acquired by searching information stores based on the dialed phone number, in accordance with exemplary embodiments of the invention.

In some embodiments of the invention, system 200 comprises three sub-systems (indicated by dashed double-edges): a telephone sub-system 210, an advertisement sub-system 230 and a search sub-system 250. Optionally, the each one of the three sub-systems 210, 230 and 250 is independent of the other one or two sub-systems.

FIG. 2 comprises dashed arrows indicating some of the data flow of system 200, and bold arrows indicating some of the controls of system 200 and dash-dot arrows indicating some of the telephonic contacts of system 200, in accordance, at least partly, with some embodiments of the invention. FIG. 2 also comprises rectangles with dual-line edges (e.g., 222), optionally representing existing entities or organizations, in accordance, at least partly, with some embodiments of the invention.

In some embodiments of the invention, telephone sub-system 210 comprises a telephone service 222, connecting a caller phone (or any other user terminal) 224 and destination party phone (or any other user terminal) 226. Optionally, telephone service 222 comprises a plurality of services cooperating and interacting to provide a connection between phones 224 and 226.

In some embodiments of the invention, advertisement sub-system 230 comprises an advertisement service 232 that receives messages (advertisements) from one or more advertisers 234 and stores them in an advertisements database 240.

In some embodiments of the invention, search sub-system 250 comprises a seeker 252, optionally comprising a plurality of modules, such as programs and/or agents. Based on a phone number 256 seeker 252 searches one or more phone directories 254 (and/or other information stores) to find one or more identification characteristics (such as party name) 258 and optionally other characteristics of the phone party such as one or more key-words 252. In some embodiments of the invention, seeker 252 stores phone number 256 in a phone numbers database 260. Optionally, seeker 252 associates (e.g., links or couples) identification characteristics 258 and other characteristics 262 with phone number 256 and stores them in a characteristics database 270. Optionally or alternatively, in some embodiments of the invention, based on phone number 256 and/or identification characteristics 258 and/or other characteristics 262, seeker 252 searches the Internet 264 to find other characteristics 262 and/or links (e.g., URL) 268 comprising phone number 256 and/or identification characteristics 258 and/or other characteristics 262. Optionally, seeker 252 associates characteristics 262 and/or links 268 with phone number 256 and stores them in characteristics database 270.

In some embodiments of the invention, system 200 comprises a dispatcher 290 that interacts with sub-systems 210, 230 and 250 as described below for some embodiments of the invention.

In some embodiments of the invention, caller phone 224 dials a destination phone number 220. Telephone service 222 detects destination phone number 220 and interacts (272) with seeker 252, providing dispatcher 290 with destination phone number 220 (274), requesting a message that matches and/or applicable to the party of destination phone number 220. Dispatcher 290 queries phone numbers database 260 (276) to check whether destination phone number 220 is available in phone numbers database 260. If destination phone number 220 is available in phone numbers database 260, dispatcher 290 retrieves destination phone number 220 (278). In some embodiments, dispatcher 290 subsequently interacts with characteristics database 270 (282) and verifies whether any characteristics 262 are associated with destination phone number 220. If positive, dispatcher 290 retrieves characteristics 262 associated with destination phone number 220 (284).

Consequently, in some embodiments of the invention, dispatcher 290 queries advertisements database 240 (286) and selects a message (advertisement) 298 that best matches and/or applicable to characteristics 262 of the party of phone number 220. Optionally, dispatcher 290 retrieves message 298 (288), or optionally otherwise accessing it (e.g., using a pointer to the message). In some embodiments of the invention, dispatcher 290 provides selected message 298 to telephone service 222 (292) that, optionally, subsequently sounds message 298 to caller phone 224.

In some embodiments of the invention, once the message is played, telephone service 222 connects caller phone 224 to destination phone 226, optionally similar or identical to a regular connection as if caller phone 224 dialed destination phone 226 in an ordinary telephone system.

In some embodiments of the invention, if dispatcher 290 does not find destination phone number 220 in database 260, dispatcher 290 invokes seeker 252 to find the number and related data as described, and optionally, if the operation is fast enough, delivers one or more suitable messages to caller phone 224. Optionally or alternatively, one or more of the messages are delivered later, such as by calling the caller and playing the message. Optionally, the number and related data are stored as described for a possible future use.

In some embodiments of the invention, if dispatcher 290 does not find a suitable or satisfactory match between an advertisement and characteristics 262 associated with destination phone number 220, dispatcher 290 invokes seeker 252 (or otherwise controls) to use links 268 associated with destination phone number 220 to further navigate (‘crawl’) Internet 264 or other information stores such as 254 to find more characteristics 262 that might yield a better match.

In some embodiments of the invention, system 200 is configured in other manners, for example as described below.

In some embodiments of the invention, databases 260 and 270 are merged into a single database. Optionally, database 240 is merged with one or both of databases 260 and 270. Optionally, one or more of databases 240, 260 and 270 comprises a plurality of databases, optionally, distributed over several computers.

In some embodiments of the invention, dispatcher 290 and/or seeker 252 are, at least partially, remote from telephone service 222 or advertisement service 232.

In some embodiments of the invention, dispatcher 290 and/or seeker 252 are, at least partially, a part of telephone service 222. Optionally, dispatcher 290 and seeker 252 are merged, at least partially, into the same program. Optionally, dispatcher 290 and/or seeker 252 are distributed over several computers.

In some embodiments of the invention, telephone service 222 and advertisement service 232 are part of the same organization, at least partially, optionally using or sharing the same computer or computers and/or the same module or modules.

### Example of a Phone Party Search

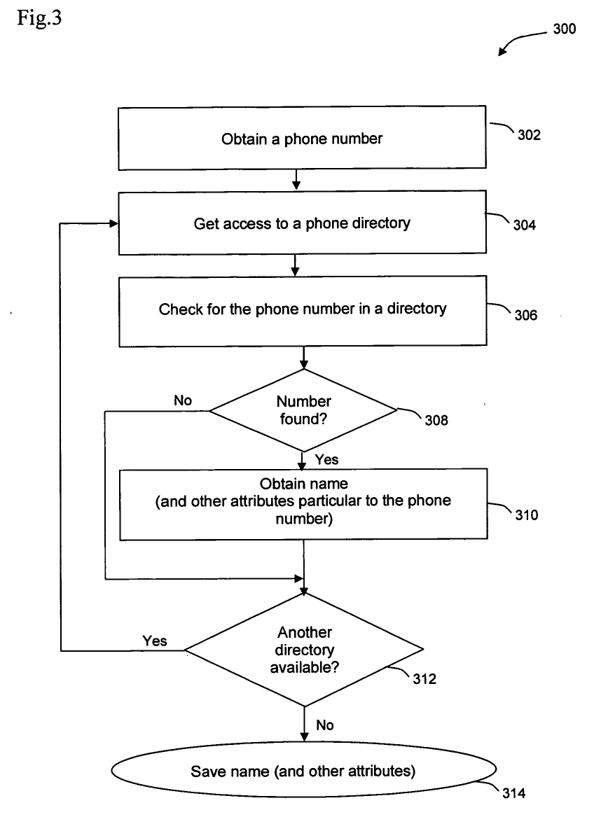

FIG. 3 is a flowchart 300 schematically illustrating finding a party based on a phone number, in accordance with exemplary embodiments of the invention.

In some embodiments of the invention, a phone number is obtained (302), for example, from the Internet, a phone directory or other information stores.

In some embodiments of the invention, an access to a phone directory (or other information store) is obtained (304), for example, from a directory list, such as Golden Pages, or via the Internet. The directory is searched to find whether the directory comprises the phone number (306). If the phone number is found (308), the directory is searched for obtaining a corresponding identification of the phone number, such as the phone party name and/or other attributes identifying or characterizing the phone party, such as address or key-words related to the phone party (310).

In some embodiments of the invention, if the phone number is not found in a directory (308), or a search of a directory is done with, a check for availability of another directory is performed (312). If another directory is available, the search is repeated (304).

In some embodiments of the invention, when the search is over, for example, satisfactory data is obtained, the data is saved, e.g., in a database (314). Otherwise, such as if no party identification (or other attributes) is found, the search is over and optionally repeated in later time when other directories are available or the directories are updated.

### Example of a Net Search

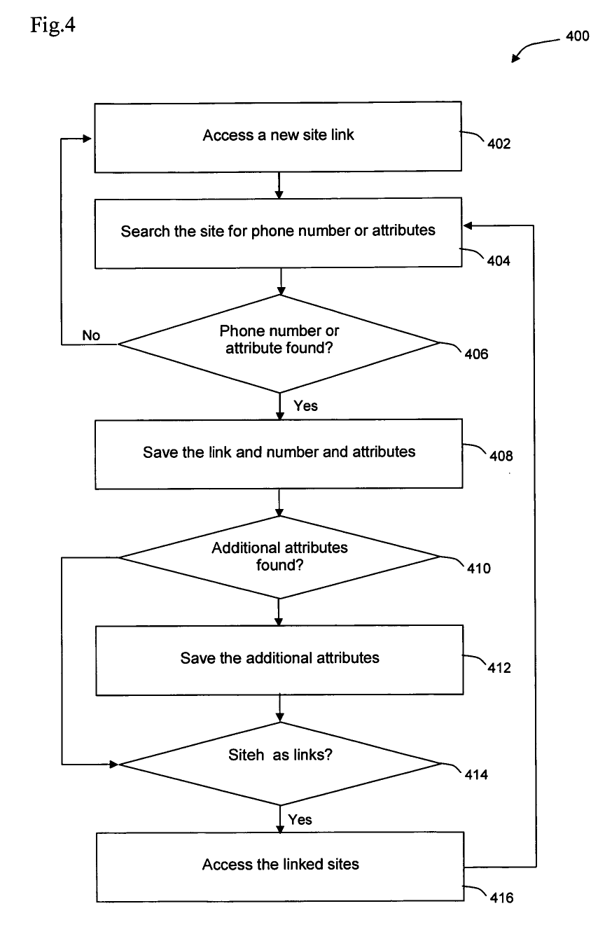

FIG. 4 is a flowchart 400 schematically illustrating a network search for phone party attributes, in accordance with exemplary embodiments of the invention.

In some embodiments of the invention, flowchart 400 applies to the Internet. Optionally, flowchart 400 applies to any connected data collections, such as a network.

In some embodiments of the invention, a new site is accessed (402). Optionally, a new site denotes a site not linked from other sites. In some embodiments of the invention, the phone number is known, optionally with one or more identifications of the phone party, such as the phone party name. Optionally or alternatively, the phone number and/or party identifications are not known and a blank search (e.g., initially not related to other data) is conducted. Optionally, a known phone and/or attributes are handled in a similar manner, at least partly.

In some embodiments of the invention, the site is searched for the phone number and attributes (404). If a known phone number and/or attributes are found any phone number and optionally attributes of the phone number party are found in the site (406), then the site link and phone number and attributes are saved, such as in a database. Optionally, the attributes and links are associated with the phone number (408). If no phone number or identification of the phone party, such as the phone party name, is found (406), a new site is tried (402).

In some embodiments of the invention, if the known number and/or identification of the phone party have been found (406), then the site is searched for additional attributes of the phone party (410). In some embodiments of the invention, in case the additional attributes are found in the site then they are saved (412), such as in a database, optionally associated with the phone number and/or identification of the phone party. In case the additional attributes are not found (410), or the additional attributes are found and optionally saved (412), the site is checked whether the site comprises links (such as URLs). In links are found, the links are followed to search the linked sites by a repeated search as described (402), optionally recursively, and optionally in parallel, such as by a plurality of agents or instances of an object in an object-oriented programming environment.

### General

All trademarks are the property of their respective owners.

In the specifications and claims, unless otherwise specified, the terms ‘software’, ‘program’, ‘procedure’ or ‘module’ or ‘code’ may be used interchangeably and denote one or more instructions, comprises in a storage medium, and executable by a computing apparatus (such as computer, processor, or a DSP or a dedicated apparatus).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, the terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a procedure” or “at least one procedure” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The present invention has been described using detailed descriptions of embodiments thereof that are provided by way of example and are not intended to necessarily limit the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to, use of features described in the context of one embodiment in the context of any other embodiment.

What is claimed is:

1. A method for delivering a message to a calling party, comprising:
(a) receiving a destination number of a destination party via a network, the destination number being dialed by a calling party;
(b) identifying data characterizing the destination party;
(c) selecting at least one message from a plurality of messages according to the identified data; and
(d) delivering the at least one message to the calling party.

2. The method of claim 1, wherein (c) is performed by a third party other than the destination and calling parties.

3. The method of claim 1, wherein each one of the plurality of messages comprises at least one advertisement.

4. The method of claim 1, wherein the data comprises information obtained based on a member selected from a group consisting of the destination number and previously obtained related data thereof.

5. The method of claim 1, wherein the identifying comprises searching at least one information store according to a member selected from a group consisting of the destination number and previously obtained related data thereof.

6. The method of claim 5, wherein the at least one information store comprises a member selected from a group consisting of: a phone directory, a business directory, social networks, business networks, a database, a data network, a computer folder, a computer document and the Internet.

7. The method of claim 5, wherein (b) and (c) are performed irrespective of (a).

8. The method of claim 5, wherein the searching is carried out by a member selected from a group consisting of: the third party and a party affiliated with the third party.

9. The method of claim 1, wherein the data comprises information obtained based on data related to parties that called the destination party.

10. The method of claim 1, further comprising (c1) associating the data with the destination number and storing the associated data before (c).

11. The method of claim 10, wherein (b), (c), and (c1) are performed irrespective of (a).

12. The method of claim 1, wherein the identifying comprises:
matching between the content of the plurality of messages and the data; and
selecting the at least one message from the plurality of messages according to the matching.

13. The method of claim 12, wherein the matching comprises finding at least one word in the plurality of messages that has at least one of a similar, an analogous or a synonym meaning as at least one word in the data.

14. The method of claim 1, wherein selecting further comprises selecting according to a member selected from a group consisting of a geographical locality of the calling party and a message already delivered to the calling party.

15. The method of claim 1, wherein the at least one message comprises a member selected from a group consisting of: a text segment, a graphic, an image, an audio file, and a video file.

16. The method of claim 1, wherein the at least one message comprises an audio sequence comprising a member selected from a group consisting of a recorded sound, a synthesized sound, and a machine reading voice.

17. The method of claim 1, wherein the at least one message comprises a media file, the delivering comprises playing the media file during a pause in a telephonic connection between the calling party and the destination party.

18. The method of claim 1, wherein the delivering comprises sending the at least one message in a member selected from a group consisting of: a short message service (SMS), a multimedia messaging service (MMS), a phone call, an email and a mail service.

19. The method of claim 1, wherein the receiving comprises receiving a paging call from the calling party.

20. The method of claim 1, further comprising benefiting the calling party from (d).

21. The method of claim 1, further comprising receiving the consent of the calling party for receiving the at least one message before the delivering.

22. A method for delivering an advertisement to calling party, comprising:
(a) receiving a destination number of a destination party from a calling party;
(b) selecting an advertisement according to data related to the destination number; and
(c) delivering the advertisement to the calling party.

23. A system for delivering a message to calling party, comprising:
a database having a plurality of destination numbers, each one of the plurality of destination numbers being associated with a destination party and charactering data related to the destination party;
a receiving unit configured for receiving one of the plurality of destination numbers, the received destination number being dialed by a calling party;
a messaging unit configured for selecting at least one message from a plurality of messages by matching between respective charactering data associated with the received destination number in the database and the plurality of messages; and
a delivering unit configured for delivering the at least one selected message to the calling party.

24. The system of claim 23, wherein the delivering unit is configured for using a telephone service for sending the at least one selected message to the calling party.

25. The system of claim 23, wherein each one of the plurality of messages comprises an advertisement.

26. The system of claim 23, wherein the messaging unit is configured for selecting the at least one message from an advertisement service providing an access to the plurality of messages.

27. The system of claim 23, wherein each said characterizing data is updated from at least one information store hosting information about a respective the associated destination party.

28. The system of claim 27, wherein the at least one information store comprises a member selected from a group consisting of: a phone directory, a business directory, social networks, business networks, a database, a data network, a computer folder, a computer document and the Internet.

29. The system of claim 23, wherein at least some of the plurality of messages comprises a member selected from a group consisting of: a text segment, a graphic, an image, an audio file, and a video file.

30. The system of claim 23, wherein the delivering unit is configured for delivering the selected message in a member selected from a group consisting of a short message service (SMS), a multimedia messaging service (MMS), a phone call, a paging call, an email and a mail.
